(19) United States
(12) Patent Application Publication
(10) Pub. No.: US 2012/0107491 A1
(43) Pub. Date: May 3, 2012

(54) High Permittivity Transparent Films

(75) Inventors: Xiaonan Li, Evergreen, CO (US); James Burst, Golden, CO (US); Timothy A. Gessert, Conifer, CO (US)

(73) Assignee: ALLIANCE FOR SUSTAINABLE ENERGY, LLC, Golden, CO (US)

(21) Appl. No.: 13/344,185

(22) Filed: Jan. 5, 2012

Related U.S. Application Data
(63) Continuation-in-part of application No. 12/130,788, filed on May 30, 2008.
Application No. 12/130,788 is a continuation-in-part of application No. 11/718,628, filed on May 4, 2007.
(60) Provisional application No. 61/489,590, filed on May 24, 2011.

(51) Int. Cl. B05D 5/12; H01B 1/02; H01B 1/00

(52) U.S. Cl. 427/109; 252/500; 252/520.1; 252/521.5; 252/512; 252/520.22; 252/520.4; 252/521.1; 427/108

(57) ABSTRACT

Thin films containing a transparent conducting oxide and a high permittivity material are disclosed. Exemplary thin films may exhibit increased transmission in the visible-to-near infrared (vis-NIR) spectrum without a decrease in electrical conductivity compared to the thin film without the high permittivity material. Methods for making thin films having enhanced optical properties without substantially decreased electrical quality are also disclosed.

### CROSS-REFERENCE TO RELATED APPLICATION

This application is a continuation-in-part of application Ser. No. 12/130,788, filed May 30, 2008, which is a continuation-in-part of application Ser. No. 11/718,628, filed on May 4, 2007, as a national-stage entry of PCT/US07/60553, filed Jan. 16, 2007. The contents of those applications are hereby incorporated by reference in their entireties for all purposes.

### CONTRACTUAL ORIGIN

The United States Government has rights in this invention under Contract No. DE-AC36-08GO28308 between the United States Department of Energy and the Alliance for Sustainable Energy, LLC, the Manager and Operator of the National Renewable Energy Laboratory.

### BACKGROUND

Transparent conducting oxide (TCO) coatings may be applied to substrates or over-coated on top of other previously deposited layers. Such layers may exhibit high transparency with electrical conductivity ranging from semiconducting to highly conducting. Accordingly, these coatings, or “thin films” as they are often referred to, may be used for a wide range of opto-electronic applications. For example, thin films may be used in the manufacture of electronic devices, such as liquid crystal displays (LCDs), and touch panel devices (e.g., personal digital assistants (PDAs) and electronic controllers), window coatings, photovoltaic solar cells and transparent thin film transistors to name only a few examples.

Metal oxides that combine electrical conductivity and optical transparency are typically intrinsically n-type due to oxygen non-stoichiometry, and include cadmium oxide, indium oxide, tin oxide and zinc oxide, which are usually alloyed or otherwise degenerately-doped to bring the conductivity to acceptable levels. However, maintaining an acceptably high conductivity typically necessitates the charge carrier concentration increasing such that optical transmission at longer wavelengths is reduced due to the absorption by the free carriers (centered at the plasma frequency). This familiar tradeoff between optical and electrical performance has driven research in the field, mainly focusing on combinations of materials that yield the best compromise between optical transmittance and electrical resistivity for a given application.

Tin oxide coated glass is the most common TCO in terms of production volume and diversity of applications, and is currently used in the production of low-emissivity glass and thin film Si- and CdTe-based photovoltaic devices. For TCO applications, tin oxide is typically doped with fluorine (referred to as FTO). The main advantages to using tin oxide are that it contains neither scarce indium nor toxic cadmium, and the optical and electrical properties remain stable in high temperature processing (>650° C.). Other benefits include long-term environmental stability and chemical resistance. However, tin oxide does not typically yield electron mobilities as high as that of indium oxide or cadmium oxide, and therefore a higher charge carrier concentration is necessary to achieve similar conductivity.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods that are meant to be exemplary and illustrative, not limiting in scope. In various embodiments, one or more of the above-described problems have been reduced or eliminated, while other embodiments are directed to other improvements.

Certain embodiments provide thin films that include a transparent conducting oxide (TCO) and a high permittivity material, wherein the thin film exhibits increased transmission in the visible-to-near infrared (vis-NIR) spectrum without a decrease in electrical conductivity compared to the thin film without the high permittivity material. In some embodiments, the increased transmission is in the near infrared (NIR) spectrum. Other embodiments provide for photovoltaic devices that may include the thin films.

In certain embodiments, the TCO may include, but is not limited to, indium (In), tin (Sn), cadmium (Cd), zinc (Zn), gallium (Ga), or an oxide of any of those elements, a host material selected from In₂O₃, CdO, SnO₂, ZnO and Ga₂O₃, a host material that is doped, or an alloy of any of the host materials. Exemplary TCOs may include fluorine (referred to as FTO).

In some embodiments, the high permittivity material may include, but is not limited to, zirconium (Zr), hafnium (Hf), titanium (Ti), vanadium (V), aluminum (Al), niobium (Nb) or tantalum (Ta), or a rare earth element or lanthanide, or an oxide of these elements, such as ZrO₂. The thin film may contain from 0.1% to 10% or from 1% to 5% of the high permittivity material.

In certain embodiments, methods of producing a thin film by are provided. In accordance with these methods, a thin film may be produced by adding a high permittivity material to a TCO and depositing the high permittivity material and TCO on a substrate to form a thin film having increased transmission in the vis-NIR spectrum. In certain embodiments, these thin films are formed without a decrease in electrical conductivity compared to a thin film without the high permittivity material.

In certain embodiments, the depositing may be accomplished by chemical vapor deposition (CVD) or sputtering or low pressure chemical vapor deposition (LP-CVD). In some embodiments, the deposition may occur at about 475° C. to 525° C. In some embodiments, zirconium tert-butoxide (ZTB) may be used as a zirconium precursor and/or tetramethyltin (TMT) may be used as a tin precursor.

In addition to the exemplary aspects and embodiments described above, further aspects and embodiments will become apparent by reference to the drawings and by study of the following descriptions. While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1 shows extracted Hall mobilities and charge carrier concentrations for several samples with varying 0-10% Zr in SnO2:F, as well as an undoped SnO₂ sample. The general trend is that carrier mobility remains above 25 for up to approximately 6% Zr when compared to SnO₂:F, while mobility and carrier concentration both decrease for greater than 8%. The electrical properties of films containing 1-3% Zr are nearly identical to that of the standard SnO₂:F.

FIG. 2 illustrates the real part of permittivity obtained by Drude-Lorentz parameterization of spectroscopic ellipsometry data for approximately 1-10% Zr in F-doped SnO₂. Undoped SnO₂:F (bottom) and ZrO₂ (top) are included for comparison.

FIG. 3 shows the transmittance and absorptance of SnO₂:F films with 0% and 1.1% Zr doping. Having similar charge carrier concentration and electron mobility, films with approximately 1% Zr display increased optical performance compared to films with 0% Zr.

FIG. 4 shows the transmittance and absorptance of SnO₂:F films with 0% and approximately 2% Zr doping (A). Having similar electrical properties (R_{S}˜10 Ω/square), films with Zr display increased transmittance in the visible and NIR compared to films with 0% Zr. Also shown is the apparent bandgap for 0% and 2% Zr in SnO₂:F (B). The slight blue shift in the band edge is likely due to alloying with the high bandgap (5.8 eV) zirconia.

FIG. 5 shows the vapor pressure curves for tetramethyltin and zirconium tert-butoxide, as calculated from Antoine coefficients.

FIG. 6 shows the refractive index, N, plotted against deposition temperature for ZrO₂.

FIG. 7 shows XPS analysis for ZrO₂ at low temperature, where significant carbon content is observed.

FIG. 8 shows the deposition rate of SnO₂ as a function of substrate temperature.

### DETAILED DESCRIPTION

Embodiments presented herein describe thin films that exhibit improved visible and near-infrared (NIR) transmission without substantial electrical property degradation. Examples include, but are not limited to, fluorine-doped tin oxide (FTO) films containing 1-5% zirconium (Zr-doped FTO films) that have similar electrical properties to FTO films, yet increased transmission when compared to FTO films. Also disclosed herein are methods for improving electrical properties in thin films (such as chemical vapor deposited (CVD) tin oxide-based films) while enhancing optical performance.

Extending the transmission bandwidth of FTO transparent electrodes in thin film photovoltaic (PV) cells may lead to increased PV cell efficiency. FTO may be used as the transparent electrode for many thin film PV cells, in part due to industry familiarity with tin oxide and existing technology for large area fabrication. However, the tradeoff between electrical and optical performance of this transparent conducting oxide (TCO) previously necessitated compromising optical transmittance at longer wavelengths to maintain the necessary electrical conductivity. For PV applications, the result was a potential 5% loss in current density for the TCO alone.

Thin films disclosed herein may include a TCO doped with a high permittivity material, which results in a thin film that exhibits increased transmission in the visible or NIR spectra without a decrease in electrical conductivity as compared to the thin film without the high permittivity material. Exemplary TCO materials may include metals such as indium (In), cadmium (Cd), tin (Sn), zinc (Zn), or gallium (Ga), or oxides of these metals. TCO materials suitable for use herein include host materials such as indium oxide (In₂O₃), cadmium oxide (CdO), tin oxide (SnO₂), zinc oxide (ZnO) or gallium oxide (Ga₂O₃), host materials that are doped with elements such as aluminum or fluorine (e.g., Al-doped ZnO, F-doped CdO, F-doped SnO₂ (FTO), etc.), and alloys of these materials (e.g., indium tin oxide (ITO), cadmium tin oxide (Cd₂SnO₄), etc.). Examples of TCO materials include In₂O₃:Sn, SnO₂:F (FTO), ZnO₂, ZnO:Al, as well as host materials or alloys of In₂O₃, CdO, SnO₂, ZnO, ZnO:Al, In₂O₃:Sn, SnO₂:F. Exemplary alloys include In—Sn—O, Cd—Sn—O, Zn—Sn—O, Al—Zn—O, In—Zn—O, In₂O₃:Ti, In₂O₃:Mo, In₂O₃:W, In₂O₃:V, In₂O₃:Cu, In₂O₃:Co, SnO₂:Sb. In some embodiments, the TCO may be a gallium-free TCO.

High permittivity materials include materials that produce large values of high-frequency dielectric permittivity when produced as an oxide, such as materials comprising the metals zirconium (Zr), hafnium (Hf), titanium (Ti), aluminum (Al), niobium (Nb), vanadium (V) or tantalum (Ta) or rare earth elements (e.g., Scandium (Sc) or Yttrium (Y)) or lanthanides such as lanthanum (La). Also included are oxides of these elements, such as TiO₂, ZrO₂, HfO₂, V₂O₅, etc. Other suitable high permittivity materials include the oxides of Al, Nb, Ta, as well as the rare-earth oxides such as Sc₂O₃ and Y₂O₃, and oxides of the lanthanides such as La₂O₃. The addition of the high permittivity material increases the optical transparency of the TCO without reducing the electrical properties of the TCO.

High permittivity materials such as Zr may be added to the TCO at a cation percentage of 0.1% to 10% or more, employing published sensitivity factors known in the art. In certain embodiments, films contain at least 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5% or 10% of the high permittivity material. Particular embodiments contain from about 0.5% to about 8% or from about 1% to about 5% of the high permittivity material. Examples include FTO containing from about 1% to about 5% Zr.

Thin films disclosed herein exhibit increased transmission in the visible or NIR spectra. The visible spectrum typically includes wavelengths from about 380 nm to about 700 nm, while the NIR spectrum typically includes wavelengths from about 800 nm to about 2500 nm. In addition, the visible-to-near infrared (vis-NIR) region typically includes wavelengths from about 380 nm to about 2500 nm. The phrase “increased transmission” refers to an increase in optical transmittance at a particular range of wavelengths in comparison to a reference film. For example, a Zr-doped FTO film's increased transmittance at a particular range of wavelengths is determined with reference to the transmittance of an FTO film that does not contain a Zr addition, over the same range of wavelengths, but otherwise demonstrates similar electrical properties and thickness. In certain embodiments, the films exhibit an increased transmittance over 380 to 1200 nm, but may also exhibit increased transmittance over any wavelength range with the visible, vis-NIR or NIR spectra.

In various embodiments, increases in transmittance over a specified wavelength range may be at least 1%, 2%, 3%, 4%, 5%, 6%, 7%, 8%, 9%, 10%, 15%, 20%, 25%, 30%, 35%, 40%, 45% or at least 50%. Other embodiments may provide increases in transmittance ranging from 1% to 50%, from 5% to 30% or from 10% to 20%. This increase in optical transmittance may also be further correlated to a larger calculated short-circuit current density in a PV device (lower loss in current density).

The thin films disclosed herein do not exhibit a decrease in electrical properties such as mobility and carrier concentration. The phrase “decrease in electrical conductivity” refers to a decrease in comparison to a reference film. For example, a Zr-doped FTO film's electrical conductivity is determined with reference to the electrical conductivity of an FTO film that does not contain a Zr addition, and the two films should have substantially similar electrical conductivities.

Thin films may be deposited on any substrate suitable for use in the production of thin films or in the deposition of TCOs. In exemplary embodiments, the substrate material may be an electrically conducting and/or transparent material, such as glass, tin oxide-coated glass, aluminosilicate glass (e.g., Corning 1737 aluminosilicate glass), copper, aluminum or other similar material. However, the substrate material is not limited to any particular type of material. The substrate material will depend at least to some extent on the application, as will be understood by those having ordinary skill in the art after becoming familiar with the teachings herein. The metal oxide coating may also be over-coated on previously deposited and processed layers on the substrate, such as, for example, when making a top contact to an opto-electronic device with a layered structure. Substrates are typically prepared by cleaning in a dilute detergent mixture (e.g., Liquinox® detergent in deionized water), sonication, and spin-rinse drying.

Properties of thin films may be determined using any suitable procedure known in the art. The films' electrical resistivity, charge carrier concentration and carrier mobility may be ascertained by Hall measurements in the van der Pauw configuration (e.g., using a Bio Rad HL5500). Optical transmittance and reflectance measurements may be used to obtain absorptance, absorption coefficient and optical bandgap data (e.g., using a Varian Cary 6i). Film thickness may be determined by stylus profilometry and spectroscopic ellipsometry (e.g., using a Dektak 8 and J. A. Woollam M-2000, respectively). Film composition may be determined from X-ray photoelectron spectroscopy (XPS) measurements, while structural aspects may be obtained from X-ray diffraction using instruments such as a Scintag 9 Diffractometer.

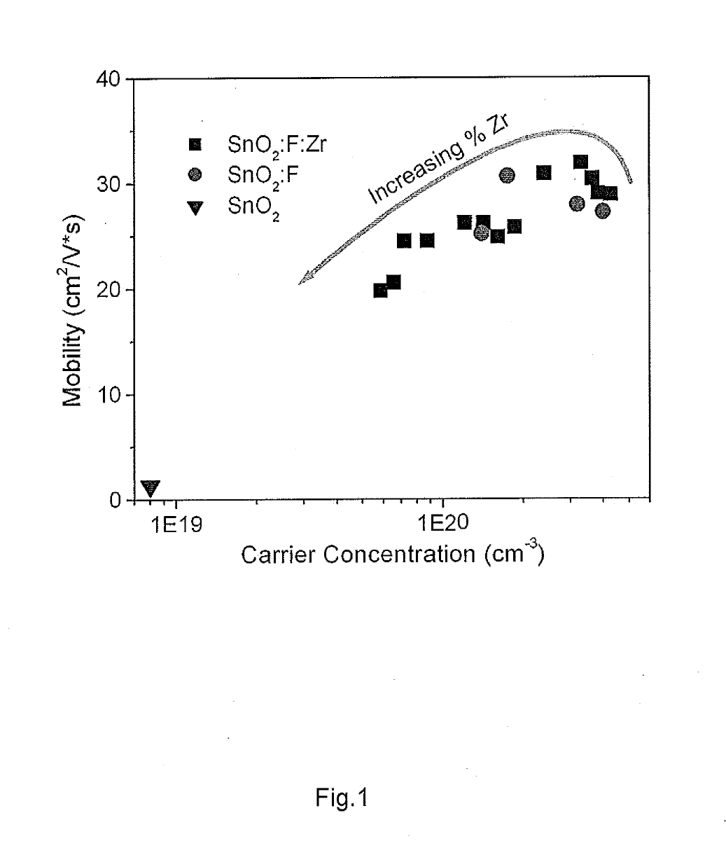

For F-doped SnO₂ alloyed with up to about 5% ZrO₂, the films retain the rutile tetragonal structure of the tin oxide host lattice and are degenerate transparent conductors, Only diffraction peaks associated with tin oxide are identified, and all doped samples have a preferred (200) texture. Exemplary films retain the high electrical conductivity of FTO, yet have improved transmittance due to the addition of zirconia. FIG. 1 shows the extracted Hall mobilities and charge carrier concentrations for several samples with varying Zr concentrations in SnO₂:F. For a complete comparison, data for an undoped SnO₂ sample and several SnO₂:F samples are also included. The general trend is that carrier mobility remains above about 25 cm²/V*s for up to about 6% Zr, while mobility and carrier concentration both decrease at greater than 8%. The electrical properties of films containing 1-5% Zr are nearly identical to that of the standard SnO₂:F. The undoped tin oxide sample has both low mobility and low carrier concentration, and XRD indicates that this is a randomly oriented polycrystalline material.

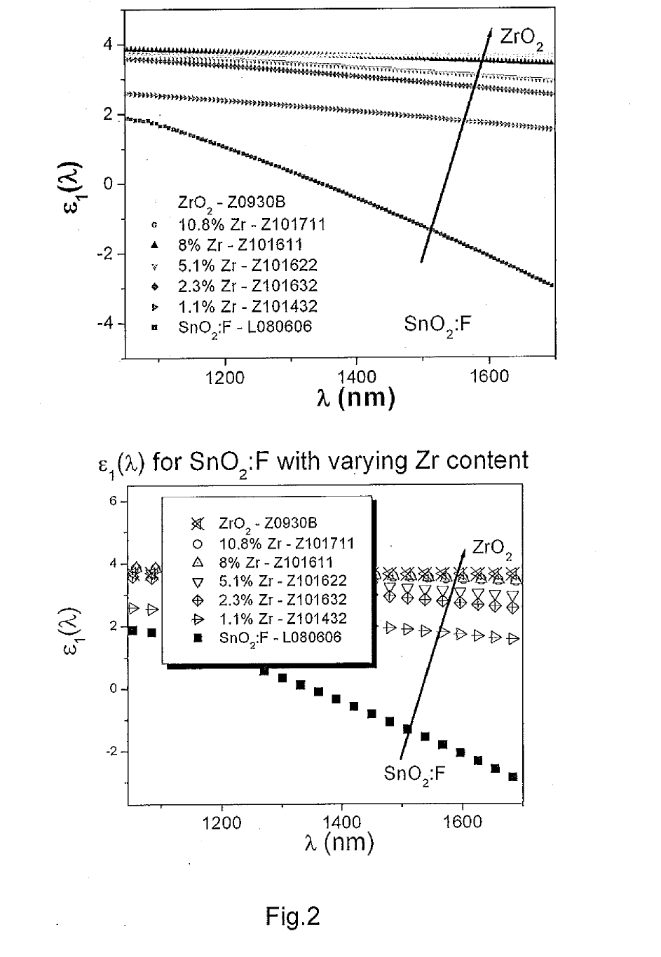

The optical properties of films with similar electrical properties and physical thickness but varying Zr content may be analyzed by spectroscopic ellipsometry. FIG. 2 shows the real part of the permittivity, ∈₁, for SnO₂:F with from 1%-10% Zr, with data for FTO and ZrO₂ included for comparison. An increase in permittivity is observed for 1% Zr addition. As Zr concentration increases to 10% and more, the observed permittivity approaches that of ZrO₂. Recalling from Drude theory that the plasma wavelength, λₚ, is centered at ∈₁=0, a shift of λₚ deeper into the IR is observed for Zr doped samples compared to the standard SnO₂:F.

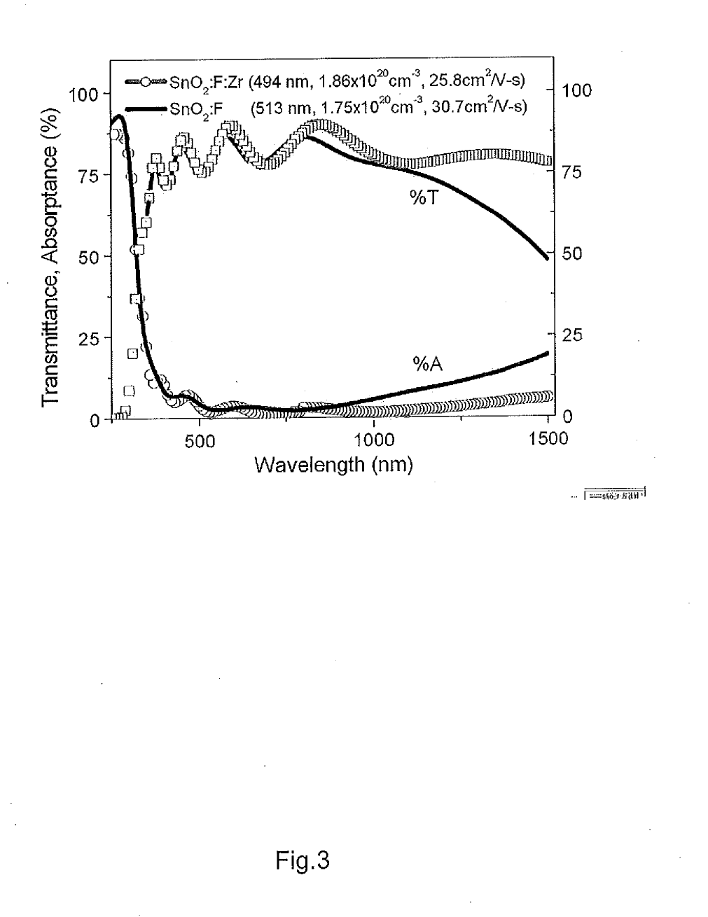

The measured transmittance and calculated absorptance of FTO and FTO with about 1% Zr is shown in FIG. 3. Though the electrical data are similar for the films, increased transmittance through most of the visible spectrum is observed, while a dramatic increase in transmittance is apparent at longer wavelengths, owing to decreased absorptance in the NIR. This increased optical performance is consistent with the shift in the plasma wavelength deeper into the IR, and attributed to the increased permittivity upon addition of Zr.

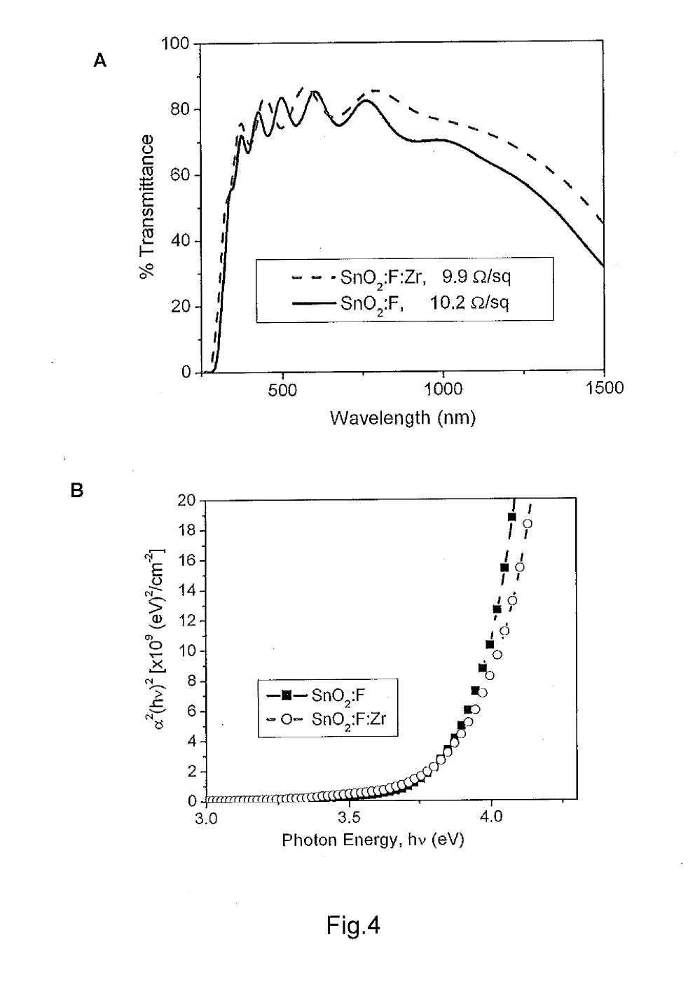

FIG. 4 shows the measured transmittance and calculated absorptance of FTO and FTO with about 1.5% Zr. These films have higher carrier concentration than those presented in FIG. 3, with a nominal sheet resistance of 10 Ω/square, which is more consistent with what may be utilized for PV applications. Again, increased transmittance through most of the visible region is observed with a slight optical bandgap widening from 3.86 eV to 3.92 eV. Because the charge carrier concentration is similar for the two films, the optical bandgap widening (blue-shift) cannot be explained by the conventional conduction band-filling mechanism. Instead, this bandgap widening may be due to the alloying effect with the wide bandgap (5.8 eV) zirconium oxide. A fairly uniform increase in transmittance is observed at near-infrared wavelengths, again due to the shift in the plasma edge.

Table 1 offers a comparison of the average optical transmittance in the visible and vis-NIR regions for the films discussed in FIG. 4. Also presented is the theoretical short-circuit current density loss due to absorption in the TCO/glass, calculated by integrating the average transmittance with the AM1.5 solar spectrum. This is done over two wavelength ranges corresponding to two thin film PV technologies, CdTe (350-860 nm) and μ-Si (350-1200 nm). Data for the glass substrate is included to illustrate the contribution of the starting material. Previous work has shown that certain glass substrates can have a large contribution in optical losses; all data presented for the films include the contribution from the substrate. The visible transmission is greater for the sample with Zr, and an approximately 10% increase in average transmission is calculated when the NIR response is included. The current density loss is 0.6 mA/cm² less for the film containing 1.5% Zr over the wavelength range pertaining to CdTe devices. For μ-Si, the difference in losses due to TCO absorption is less dramatic, despite the apparent enhanced transmission at longer wavelengths. This is due to the fact that much less solar radiance is incident at these longer wavelengths. Finally, a figure of merit (FOM), which weighs the integrated (visible) transmittance and sheet resistance (Φ=T¹⁰/R_{S}, as explained by Haacke et al., Journal of Applied Physics 47:4086 (1976)), is also presented. This method gives more weight to the optical transmission than other methods, which is perhaps more relevant for comparing films intended for PV applications. The film with Zr shows an enhancement in the FOM compared to a film without ZR, which is consistent with an increase in visible transmittance.

TABLE 1

| | | | J_{SC} loss, | J_{SC} loss, | | |
|---|---|---|---|---|---|---|
| | | | 350- | 350- | | |
| | % T | % T | 860 nm | 1200 nm | R_{S} | Φ |
| Sample | (vis) | (vis-NIR) | (mA/cm²) | (mA/cm²) | (Ω/ ) | (10⁻³) |
| SnO₂:F | 79% | 69% | 2.67 | 4.53 | 10.2 | 9.3 |
| SnO₂:F:Zr | 81% | 79% | 2.07 | 4.3 | 9.9 | 12 |
| Corning 1737 | 91% | 91% | 0.18 | 0.37 | n/a | n/a |
| substrate | | | | | | |

% T (vis): optical transmittance in the visible region (380-700 nm);
% T (vis-NIR): optical transmittance in the visible-to-infrared region (380-1200 nm);
J_{SC} loss: short-circuit current density loss;
R_{S}: sheet resistance;
Φ: Haacke's figure of merit

Tuning the properties of TCOs has historically involved attempts at achieving or maintaining reasonably high mobility, while modifying the charge carrier concentration to obtain suitable electrical and/or optical performance. This process invariably results in a compromise toward optimization of either the electrical or optical properties. The embodiments and data presented herein demonstrate that alloying with TCOs high-κ oxides such as ZrO₂ allows the tuning of mobility and carrier concentration as well as the additional adjustment of permittivity engineering. Further, this additional tuneability does not negatively interfere with the electrical properties associated with mobility and carrier concentration.

The films may be produced by low pressure chemical vapor deposition (LP-CVD), consistent with current processes for large-area fabrication, such as by the methods described in Li et al., Applied Surface Science 223:138 (2004). Exemplary low pressure metal-organic chemical vapor deposition processes are also provided in the Example below. However, other types of deposition processes, such as chemical vapor deposition, physical vapor deposition or others, now known or later developed, are also contemplated as being suitable for the described purposes. Sputtering is a physical vapor deposition (PVD) process well known as a means of depositing metal oxide layers (or thin films) on a substrate. Selection of a suitable deposition process may depend on the content of the thin film and/or the desired properties of the thin film, as is known to one of skill in the art.

In certain embodiments, the films may be produced by chemical vapor deposition (CVD) using zirconium tert-butoxide (ZTB) as the zirconium precursor. In some embodiments, the films may be produced by CVD using tetramethyltin (TMT) as the tin precursor. CVD techniques employing both ZTB and TMT as precursors are also suitable for producing the thin films described herein.

For example, Zr-doped FTO films with similar electrical properties but higher permittivity compared to undoped FTO films can be synthesized by combinatorial CVD. The higher permittivity leads to an observed higher optical transmittance, particularly in the near infrared. This may be attributed to the plasma edge, that is, the frequency at which the free electrons resonate with incident radiation, being shifted to longer wavelengths. Permittivity engineering may be extended to other oxide systems, and perhaps enhanced by alloying with even higher permittivity materials. Additionally, other materials may be added that although they do not directly increase permittivity, they may enable the material to form into a higher permittivity oxide.

The deposition processes may also include additional operations. In an exemplary embodiment, the substrate material having the deposited metal oxide thin film may be thermally annealed. Other operations may include varying operating parameters, such as temperature, relative concentrations of the metal ions, etc. Still other operations may also be implemented, as may be required to produce composite materials with the desired physical and electronic properties.

It is readily appreciated that applications of this technology may include, but are not limited to, architectural windows, flat-panel displays, liquid crystal displays (LCDs), thin-film photovoltaic devices, electrochromic windows, polymer-based electronics, touch panel devices (e.g., personal digital assistants or PDAs), photovoltaic solar cells, transparent thin film transistors, low-emissivity window glass, devices that benefit from control of work function, and other opto-electronic applications.

By way of example, the development of multi-junction thin-film photovoltaic solar cell devices with high conversion efficiencies may be accomplished by incorporating the thin films described herein into photovoltaic devices that have much higher NIR transmission than found in traditional TCOs. The increased transmittance of the thin films described herein may also enable lower power consumption in flat panel displays (and hence a longer battery lifetime). The thin films may also exhibit enhanced wear-resistance, mechanical durability, and/or chemical resistance.

Examples are included to illustrate various embodiments. It should be appreciated by those of skill in the art that the techniques disclosed in the examples that follow represent techniques discovered to function well in the practice of the claimed methods, compositions and apparatus. However, those of skill in the art should, in light of the present disclosure, appreciate that many changes may be made in the embodiments which are disclosed and still obtain a like or similar result without departing from the spirit and scope of the invention.

### EXAMPLE

### Example 1

This Example demonstrates the production of thin films using low pressure metal-organic chemical vapor deposition and analysis of the resulting thin films.

SnO₂, ZrO₂ and SnO₂—ZrO₂ thin films were produced by low pressure metal-organic chemical vapor deposition. The dense films have high visual transparency (>80%), good adherence to the glass substrate, and are resistant to chemical etching (i.e., are environmentally stable). The ZrO₂ films are mostly amorphous, while the rutile (tetragonal) SnO₂ is randomly oriented. Fluorine-doping of the SnO₂ and SnO₂—ZrO₂ (up to 10% Zr) mixed oxide films induces a strong preferential (200) texture. The F-doping level is in the range of 1-3%; Hall measurements indicate the n-type carrier concentration on the order of 10²⁰ cm⁻³ and carrier mobilities up to 30 cm²/V-s. The optical bandgap and near-infrared transparency of SnO₂ films increases with ZrO₂ addition.

The LP-CVD system used was a modified low pressure metalorganic (MO) CVD reactor (CVD Equipment Corp., Ronkonkoma, N.Y.; see Xi et al., Applied Surface Science 223:38 (2004)). The reactor was a cold wall quartz tube design with four gas inlet injectors. Chamber and precursor pressures were monitored by capacitance manometer gauges (MKS Baratron, MKS Instruments, Andover Mass.). Ultra-high purity (UHP) O₂ was the oxidant and N₂ the carrier and diluent gas. Precursor, diluent and reactant gases enter the chamber through their respective injectors, flowing the length of the chamber and are then pumped at the other end. The graphite susceptor is machined for sample sizes up to 10 cm wide×30 cm in length and 1.1 mm thickness. The sample is heated from below by 5-zone independently controlled IR lamps. The substrates used in this study are 1 mm thick, 10 cm×10 cm square, Corning 1737 aluminosilicate glass. Individual substrate slides were cleaned by loading into a Fluoroware spin-rinse-dryer (SRD) compatible carrier, soaking in a dilute Liquinox® detergent+20 MΩ de-ionized (DI) water solution at 80° C. for approximately 2 hours, then sonication for 5-10 minutes. The substrate slides are manually rinsed and sonicated up to 5 more times, then rinsed and dried in a cleanroom SRD to output resistance of 18 MΩ

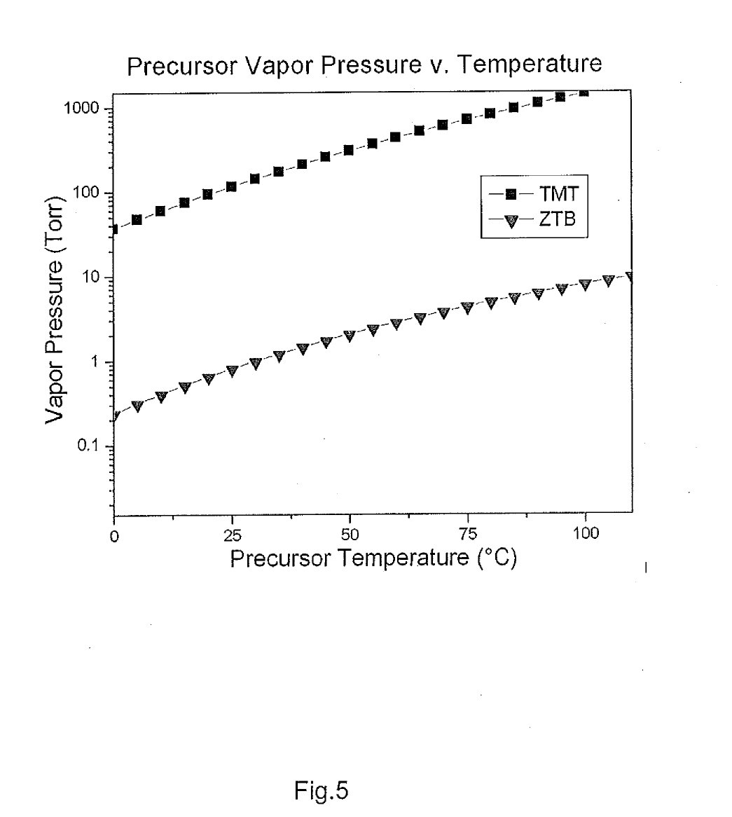

The starting precursors are liquid at room temperature. The metal organics used are tetramethyltin (TMT, Epichem/SAFC or Air Products, Allentown, Pa.) and zirconium tert-butoxide (ZTB, Air Products). Bromotrifluoromethane (CBrF₃) was used for the fluorine dopant. The calculated (vendor-supplied Antoine coefficients) MO vapor pressure curves are shown in FIG. 5. The MO precursors were delivered by N₂ carrier gas flowed through respective bubblers. The bubbler outlet pressures were set to 200 Torr and 80 Torr for TMT and ZTB, respectively.

Composition and chemical state of the films was determined by x-ray photoelectron spectroscopy (XPS, Phi 5000 VersaProbe) using a monochromated Al—Kα source anode. Survey scans were taken with a pass energy of approximately 100 eV, while high resolution scans of individual peaks were taken over several iterations at a pass energy of 23.5 eV, resulting in an overall resolution of approximately 0.5 eV. The data were analyzed using commercial software (Phi MultiPak, CasaXPS). The structure of the films was obtained from x-ray diffraction (XRD, Scintag PTS) in the 0-20 mode with 0.02° step size.

The film thickness, surface roughness and optical parameters were acquired by modeling the data obtained from spectroscopic ellipsometry (J. A. Woollam M-2000 or α-SE) using Woollam's W-VASE and CompleteEASE software, respectively. The 3-layer model consists of: glass substrate with backside reflection, a graded Drude-Lorentz model of the film's bulk properties, and a Bruggeman effective medium approximation (EMA) layer to model the surface roughness. The extracted thicknesses were compared to that obtained using a stylus profilometer (Dektak 8). The surface roughness is evaluated with respect to atomic force microscopy (AFM) measurements.

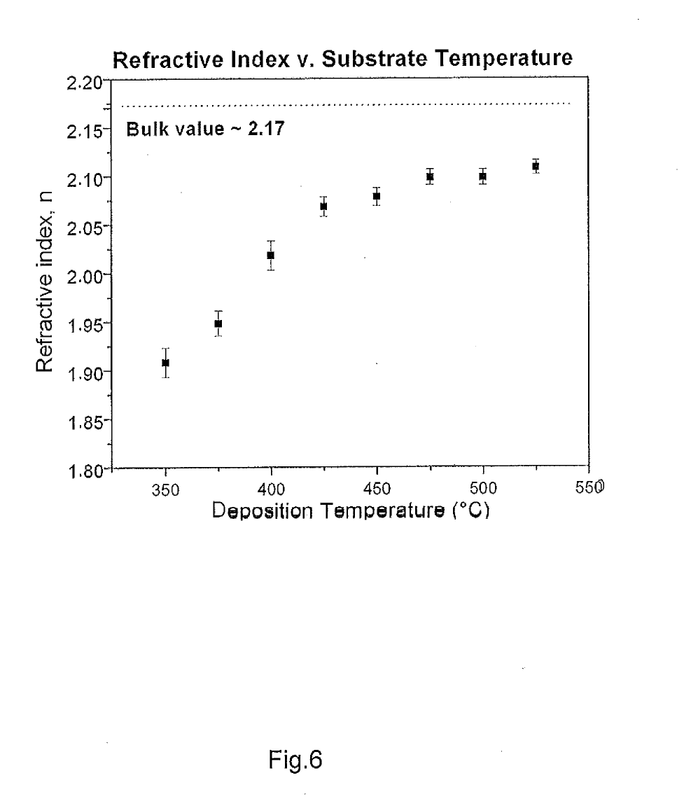

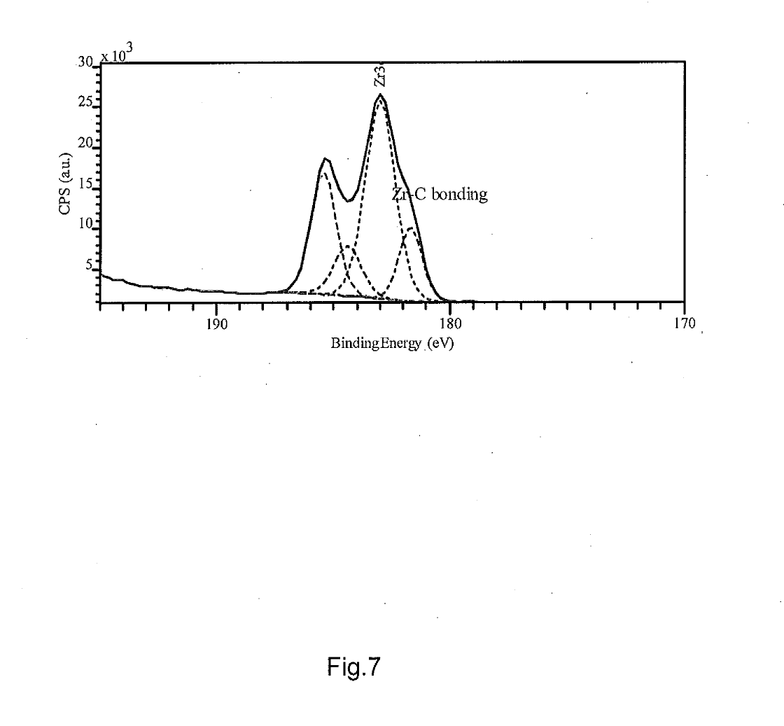

ZrO₂ films were deposited at a total pressure of 20 Torr. The ZTB bubbler temperature was varied in the range of 50-65° C. To prevent condensation of the precursor between the bubbler and chamber, the gas delivery lines were heated to approximately 80° C. In the temperature range used, 350-550° C., the ZrO₂ films are amorphous. However, the refractive index, N, increases with temperature up to about 475° C. (FIG. 6). This may be due to a high void fraction resulting in lower density films at the lower temperatures, consistent with observations detailed in Song et al., Journal of Vacuum Science & Technology A 22:711 (2004). The average deposition rate ranges from approximately 5-10 nm/minute. At 350-375° C., higher deposition rates were observed, but a lower index of N=1.9−1.95 and the overall optical transmittance is reduced from 86% to 74% for approximately 500 nm thick films. XPS analysis (FIG. 7) indicates that these films contain a significant amount of carbon. Peaks associated with ZrO₂ and Zr—C bonding are observed in the Zr-3d lineshapes. From this we conclude that at lower temperatures, the precursor is depositing on the substrate more quickly than it can fully decompose and the result is carbon contamination and poor film quality.

In the range of 400-525° C., the deposition rates do not change substantially at specific positions in the reactor and the refractive index, N ranges from 2.02-2.11 (at λ=632.8 nm). With XPS, only peaks associated with oxygen and zirconium are evident in the bulk of the film. Carbon was detected before sputtering, however, after a 30-60 second sputter clean, the C-1s peak is substantially reduced and not well-resolved given our experimental conditions. At higher temperatures, material is deposited on the leading edge of the susceptor (sample holder), which is probably compensating for what might otherwise be an increase in observed deposition rate on the substrate, which is approximately 5 cm downstream. At 550° C.; continuous film deposition has ceased, and gas phase reactions occur. This is evident by small inclusions observed in the film, and also a powdery substance (identified as ZiO₂ with carbon) formed on the substrate holder. In summary, given the aforementioned experimental conditions, a temperature range of 475-525° C. appears advantageous.

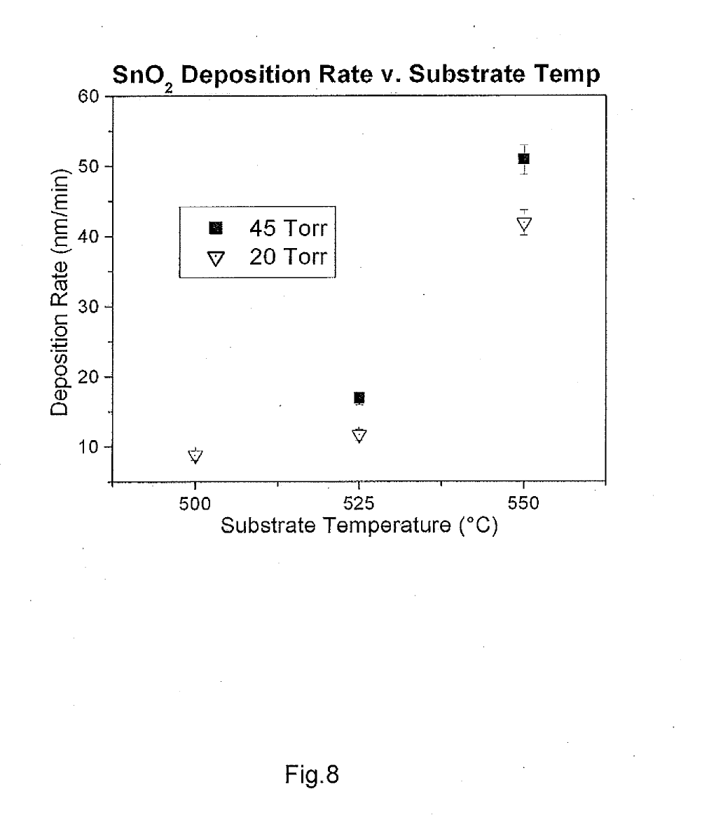

SnO₂ films were deposited in the range of 500-550° C. with deposition rates ranging from approximately 8-50 nm/minute (FIG. 8). The deposition rate was low below 500° C. in the pressure regime studied (20-45 Torr). Though the film properties did not change with pressure, the deposition rate was higher at 45 Torr and uniformity of deposition along the length of the reactor was achieved.

Unintentionally doped tin oxide is a weak n-type semiconductor due to variation from stoichiometry (H⁺ inclusions, interstitial tin and/or oxygen vacancies). These intrinsic SnO₂ (i-SnO₂) films are polycrystalline with a rutile (tetragonal) structure. The films have a high optical transmittance (>80%) associated with a resistivity of about 1 Ω-cm and an optical bandgap of about 3.6 eV. Fluorine-doping increases both the carrier concentration, from 8×10¹⁸ cm⁻³ to about 4×10²⁰ cm⁻³, and the carrier mobility, from about 1 cm²/V-s to about 30 cm²/V-s. The increase in mobility is associated with a strong, preferentially (200) orientation upon F-doping. The increase in charge carrier concentration induces a large increase in the optical bandgap, up to about 3.87 eV, due to a blue shift in the transmittance spectra. This is explained in the context of the conduction band filling with ionized impurities due to degenerately doping. The lowest resistivity, x 10⁻⁴ Ω-cm, is achieved for flow rates of oxygen and fluorine precursors, F_{O2}/F_{CBrF3},=1.5, where the F-doping level is 2%±0.5%.

From the CVD work on SnO₂ and ZrO₂ done separately, an overlap in deposition temperature was observed in that we can deposit films in the range of 500-545° C. The Zr-doped tin oxide depositions were designed by simply combining the process parameters of the individual runs.

For Zr concentrations higher than about 5%, the sheet resistance, R_{S} increases sharply. To separate the effect of film thickness on R_{S}, Hall measurements were utilized. It was noted that even for up to ˜10% Zr in SnO₂:F films, carrier mobility is still above 20 cm²/V·s and charge carrier concentrations vary in the range of 0.5-2.5×10²⁰ cm⁻³. The bandgap increases to 3.92 eV (from 3.87 eV for SnO₂:F) for a sample with 2.8% Zr addition. A trend was observed in increasing transmission in the NIR for increasing Zr content.

The Example discussed above is provided for purposes of illustration and is not intended to be limiting. Still other embodiments and modifications are also contemplated.

While a number of exemplary aspects and embodiments have been discussed above, those of skill in the art will recognize certain modifications, permutations, additions and sub combinations thereof. It is therefore intended that the following appended claims and claims hereafter introduced are interpreted to include all such modifications, permutations, additions and sub-combinations as are within their true spirit and scope.

The following is claimed:

1. A thin film having increased transmission in a light spectrum without a decrease in electrical conductivity comprising:
a transparent conducting oxide that is doped with fluorine; and
a high permittivity material, wherein the high permittivity material ranges from 0.1% to 10% of the thin film.

2. The thin film according to claim 1, wherein the transparent conducting oxide that is doped with fluorine further comprises a host material selected from a group consisting of: F-doped CdO, F-doped SnO₂, and alloys of F-doped CdO and F-doped SnO₂.

3. The thin film according to claim 1, wherein the transparent conducting oxide comprises a transparent conducting oxide doped with CBRF₃.

4. The thin film according to claim 1, wherein the high permittivity material is selected from a group consisting of: zirconium (Zr), hafnium (Hf), titanium (Ti) vanadium (V), aluminum (Al), niobium (Nb), tantalum (Ta), a rare earth element or lanthanide, and an oxide of any of these elements.

5. The thin film according to claim 1, wherein the high permittivity material comprises zirconium.

6. The thin film according to claim 1, wherein the high permittivity material ranges from 5.5% to 10% of the thin film.

7. The thin film according to claim 1, wherein the high permittivity material ranges from 1% to 5% of the thin film.

8. The thin film according to claim 6, wherein the high permittivity material comprises zirconium oxide.

9. The thin film according to claim 1, wherein the light spectrum comprises a visible-to-near infrared (vis-NIR) spectrum and wherein the increased transmission comprises an increase of 5% to 30% compared to a transparent conducting oxide without the high permittivity material.

10. A photovoltaic device comprising the thin film of claim 1.

11. A method of producing a thin film having increased transmission in a light spectrum without a decrease in electrical conductivity comprising:
adding a high permittivity material to a transparent conducting oxide, wherein the high permittivity material ranges from 0.1% to 10% of the thin film and wherein the transparent conducting oxide is a gallium-free transparent conducting oxide; and
depositing the high permittivity material and transparent conducting oxide on a substrate to form a thin film.

12. The method according to claim 11, wherein depositing the high permittivity material and transparent conducting oxide on the substrate comprises using chemical vapor deposition (CVD) or sputtering.

13. The method according to claim 11, further comprising applying zirconium tert-butoxide (ZTB) as a zirconium precursor.

14. The method according to claim 1, further comprising applying tetramethyltin (TMT) as a tin precursor.

15. The method according to claim 1, wherein depositing the high permittivity material and transparent conducting oxide on the substrate is accomplished by low pressure chemical vapor deposition (LP-CVD).

16. The method according to claim 11, wherein depositing the high permittivity material and transparent conducting oxide on the substrate occurs at about 475° C. to 525° C.

17. The method according to claim 11, wherein the transparent conducting oxide comprises indium (In), tin (Sn), cadmium (Cd), zinc (Zn), or an oxide of any of these elements.

18. The method according to claim 11, further comprising doping the transparent conducting oxide with fluroine.

19. The method according to claim 11, wherein the high permittivity material comprises zirconium (Zr), hafnium (Hf), titanium (Ti), vanadium (V), aluminum (Al), niobium (Nb), tantalum (Ta), a rare earth element or lanthanide, or an oxide of any of these elements.

20. The method according to claim 11, wherein the high permittivity material comprises zirconium.

21. The method according to claim 20, wherein the high permittivity material ranges from about 1% to 5% of the thin film.

22. The method according to claim 11, wherein the transparent conducting oxide comprises tin oxide doped with fluorine.

23. The method according to claim 11, further comprising fabricating a photovoltaic device from the thin film.

24. A method of producing a thin film having increased transmission in a light spectrum from about 380 nm to about 700 nm without decreasing electrical conductivity in the thin film, the method comprising:
providing a transparent conducting oxide;
doping the transparent conducting oxide with fluorine;
adding a high permittivity material to the fluorine-doped transparent conducting oxide, wherein the high permittivity material ranges from 0.1% to 10% of the thin film; and
depositing the high permittivity material and fluorine-doped transparent conducting oxide on a substrate to form the thin film.

25. The method according to claim 24, wherein doping the transparent conducting oxide with fluorine comprises doping the transparent conducting oxide with CBRF₃.

26. The method according to claim 25, further comprising applying zirconium tert-butoxide (ZTB) as a zirconium precursor, and wherein depositing the high permittivity material and fluorine-doped transparent conducting oxide on the substrate to form the thin film comprises: depositing the high permittivity material and fluorine-doped transparent conducting oxide on the substrate using chemical vapor deposition (CVD).

27. The method according to claim 24, wherein the increased transmission comprises an increase of 5% to 30% compared to a TCO without the high permittivity material.

28. The method according to claim 24, further comprising fabricating a photovoltaic device using the thin film.
